(19) United States
(12) Patent Application Publication
(10) Pub. No.: US 2003/0022704 A1
(43) Pub. Date: Jan. 30, 2003

(54) Method for saving power of cellular phone

(75) Inventor: Ching-Yuan Lin, Taipei Hsieng (TW)

Correspondence Address: BACON & THOMAS, PLLC, 625 SLATERS LANE, FOURTH FLOOR, ALEXANDRIA, VA, 22314

(73) Assignee: Inventec Appliances Corp., Hsieng (TW)

(21) Appl. No.: 09/912,298

(22) Filed: Jul. 26, 2001

(51) Int. Cl. H04M 1/00

(52) U.S. Cl. 455/574; 455/572; 455/573; 455/343

(57) ABSTRACT

In a cellular phone having a central processing unit (CPU), a power saving method comprises the steps of (a) displaying predetermined icons on a display in an unused mode; (b) determining whether a receiver circuit of the cellular phone is disconnected from a telephone network; and (c) if result in step (b) is positive sending a sleep signal to a control chip of the cellular phone for causing the cellular phone to enter into a power saving mode by blanking the display. This can reduce power consumption while searching a telephone network, resulting in an increase of service time per charge.

### FIELD OF THE INVENTION

The present invention relates to cellular phones and more particularly to a method for saving power when a cellular phone is looking for a telephone network.

### BACKGROUND OF THE INVENTION

Recently, as to the research and development of cellular phones there are two main fields. Namely, one is how to incorporate more features into a cellular phone (i.e., multifunctional cellular phone). The other is power saving so as to increase service time per full charge. Typically, as to the operation of cellular phone a telephone conversation consumes much more power than standby. Moreover, most power is consumed when cellular phone is continuously looking for a telephone network until connected. Typically, cellular phone can not enter a power saving mode automatically while searching a telephone network. In contrast, it is typical for cellular phone user to enter a power saving mode manually while searching a telephone network. It is known that cellular phone is a portable electronic device. It is also known that in many conditions the signal strength is weak. Hence, cellular phone user may not be able to determine when the cellular phone will get connected if the cellular phone is in a search mode. As a result, it is impossible to effectively save power of cellular phone by performing a manually activated power saving mode.

### SUMMARY OF THE INVENTION

It is therefore an object of the present invention to provide a power saving method implemented in a cellular phone having a central processing unit (CPU).

The method comprises the steps of (a) displaying a plurality of predetermined icons on a display of the cellular phone in an unused mode; (b) determining whether a receiver circuit of the cellular phone is disconnected from a telephone network; and (c) if result in step (b) is positive sending a sleep signal to a control chip of the cellular phone for causing the cellular phone to enter into a power saving mode by blanking the display, showing a background color on the display, and deactivating memory. In the power saving mode if cellular phone is connected to the telephone network or a key of the cellular phone is pressed even when the cellular phone is disconnected from the telephone network, the method further comprises the step of (d) sending a wakeup signal to the control chip of the cellular phone for causing the cellular phone to loop back to unused mode in step (a).

The above and other objects, features and advantages of the present invention will become apparent from the following detailed description taken with the accompanying drawings.

### BRIEF DESCRIPTION OF THE DRAWINGS

FIG. 1 is a flow chart illustrating a process for saving power of cellular phone according to the invention.

### DETAILED DESCRIPTION OF THE PREFERRED EMBODIMENTS

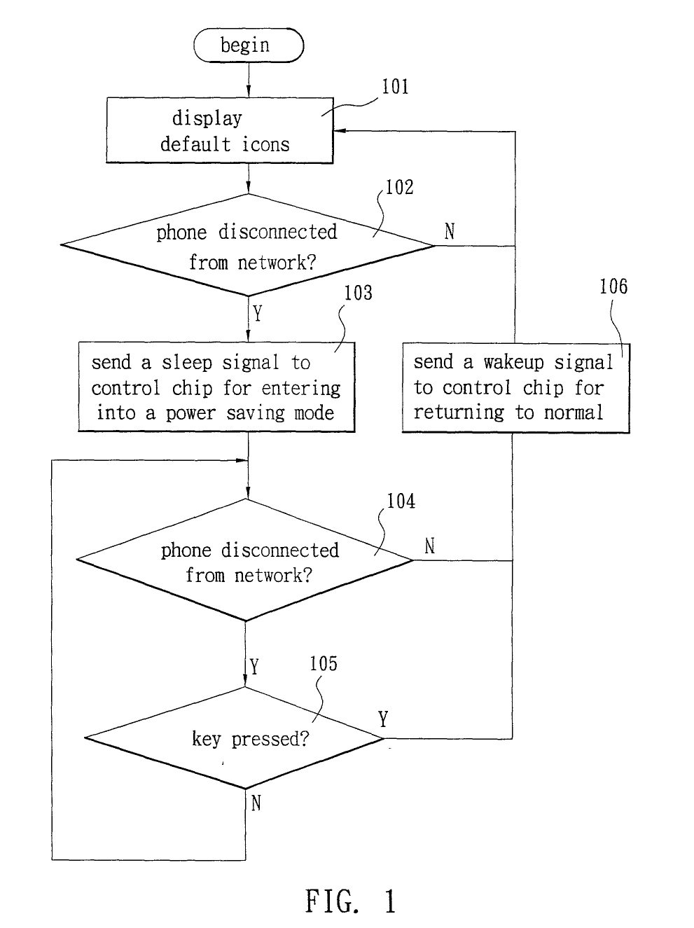

Referring to FIG. 1, a process for saving power of cellular phone in accordance with the invention is illustrated. First turn on cellular phone. A central processing unit (CPU) of cellular phone then performs the following steps: In step 101, display default icons on display in an unused mode. In step 102, determine whether a receiver circuit of cellular phone is disconnected from telephone network. If yes, the process goes to step 103. If not, the process loops back to step 101. In step 103, send a sleep signal to a control chip of cellular phone for commanding it to cause cellular phone to enter into a power saving mode by blanking the display, showing a background color on the display, and deactivating memory. In step 104, determine whether receiver circuit of cellular phone is disconnected from telephone network. If yes, the process goes to step 105. If not, the process goes to step 106. In step 105, determine whether one of a plurality of keys of cellular phone is pressed. If yes, the process goes to step 106. If not, the process loops back to step 104. In step 106, send a wakeup signal to the control chip of cellular phone for commanding it to cause cellular phone to return to the unused mode (step 101) by showing the default icons on display, showing a normal color, and activating memory. By implementing this, it is possible to significantly reduce power consumption when a cellular phone is looking for a telephone network, resulting in an increase of service time per full charge of cellular phone.

While the invention has been described by means of specific embodiments, numerous modifications and variations could be made thereto by those skilled in the art without departing from the scope and spirit of the invention set forth in the claims.

What is claimed is:

1. In a cellular phone having a central processing unit (CPU), a method for saving power of said cellular phone comprising the steps of:
(a) displaying a plurality of predetermined icons on a display of said cellular phone in an unused mode;
(b) determining whether a receiver circuit of said cellular phone is disconnected from a telephone network;
(c) if result in step (b) is positive sending a sleep signal to a control chip of said cellular phone for causing said cellular phone to enter into a power saving mode and looping back to step (b) else jumping to step (d); and
(d) sending a wakeup signal to said control chip of said cellular phone for causing said cellular phone to loop back to step (a).

2. In a cellular phone having a central processing unit (CPU), a method for saving power of said cellular phone comprising the steps of:
(a) displaying a plurality of predetermined icons on a display of said cellular phone in an unused mode;
(b) determining whether a receiver circuit of said cellular phone is disconnected from a telephone network;
(c) if result in step (b) is positive sending a sleep signal to a control chip of said cellular phone for causing said cellular phone to enter into a power saving mode and looping back to step (b) else jumping to step (d);
(d) determining whether one of a plurality of keys of said cellular phone is pressed; and
(e) if result in step (d) is positive sending a wakeup signal to said control chip of said cellular phone for causing said cellular phone to loop back to step (a).

3. The method of claim 1 or 2, wherein said cellular phone enters said power saving mode by blanking said display.

4. The method of claim 3, wherein said cellular phone enters said power saving mode by showing a background color on said display.

5. The method of claim 4, wherein said cellular phone enters said power saving mode by deactivating a memory of said cellular phone.
